(19) United States
(12) Patent Application Publication
(10) Pub. No.: US 2013/0173477 A1
(43) Pub. Date: Jul. 4, 2013

(54) Storing and forwarding credentials securely from one RFID device to another

(71) Applicant: Geoffrey I. Cairns, Redmond, WA (US)

(72) Inventor: Geoffrey I. Cairns, Redmond, WA (US)

(21) Appl. No.: 13/589,113

(22) Filed: Aug. 18, 2012

Related U.S. Application Data
(60) Provisional application No. 61/525,187, filed on Aug. 19, 2011.

(51) Int. Cl. G06Q 20/32

(52) U.S. Cl. CPC G06Q 20/3226
USPC 705/76

(57) ABSTRACT

Storing and forwarding credentials securely from one RFID device to another includes a system and method of securely storing credentials onto a tamperproof module with a Poken-like Device, and using that device in connection with a Padloc, iPhone or Smartphone in a known paired relationship to securely provide a user credentials for resources the Padloc, iPhone or Smartphone applications are attempting to access.

### PRIORITY CLAIMS

This application claims priority from Provisional Application No. 61/525,187 filed on Aug. 19, 2011, which is incorporated herein by reference in its entirety.

System and methods for storing and forwarding credentials used for payment transaction, access to resources, or other that are securely held one device and able to be transferred to another device.

### FIELD OF INVENTION

The secure transfer of electronic credentials from one mobile device to another.

### BACKGROUND

Cross-References to Related Applications

PCT US 2011/064173 Hand-held Self-Provisioned PIN PED Communicator

As mobile commerce adoption continues, mobile network devices such as Smartphones or iPhones and their associated e-wallet applications will include more user-specific payment options. For example, users will include their payment information from credit cards such as American Express, Visa, or MasterCard; loyalty cards; or pre-paid debit cards.

These mobile devices will increasingly include non-payment identity and security credentials used for such things as accessing accounts, logging into websites, signing on to systems, and gaining access to physical assets, for example for opening a locked automobile door or entering a gate.

In addition to these mobile network devices, other secure portable devices are emerging that will be used, either stand alone or connected to an e-wallet application on a network device, to store identity and security credential information for the payment and access functions described above. These devices will have the characteristics of being secure, tamperproof, and able to function independent of access to the network.

An example of such a device is the Padloc, from NFC Data, Inc. Padloc is a hand-held mobile device that contains a dedicated tamperproof module used for storing and securely transmitting user identity and credential information. Padloc is a very small device that connects to the dock of Apple devices or micro USB for Androids. It has an NFC reader/antenna which may serve as a reader/writer. It also has a biometric reader. Note: these items may be already in phone like the Nexus S with NXP chip and authentic biometric reader. It has a unique serial encoded IC and can talk to the dial pad as a security PIN Pad. It has an application on the network that it pairs with and it can pair with other NFC, Bluetooth or Wifi transmitters. It uses HSM DUKPT technology for session secure control. Padloc need not be on the Network device (e.g. attached to the phone) to read and store NFC data. It uses store and forward to work synchronously or asynchronously.

Users with multiple mobile network devices may prefer to have the electronic credentials used by each device stored securely on a separate Poken-like Device that is kept on the user, for example in the user's pocket or purse. The Poken-like device, containing a tamperproof module, is securely electronically paired with the user's mobile network devices and securely provides user credentials when demanded by the mobile network device. The user supplies a PIN, or uses a biometric reader to authenticate the user and to complete the pairing between the Poken-like Device and the network mobile device.

An example of this Poken-like Device is the “Easy Cube” device described in http://www.nfcworld.com/2010/10/19/34725/chunghwa-telecom-test-bluetooth-nfc-device-taipei/

A way of implementing multiple credentials in a single card is described in http://www.popsci.com/gadgets/article/2010-09/smart-multi-account-credit-cards-come-ebedded-computers-preventing-theft-and-reducing-card-clutter

A way of inserting credentials into a device is disclosed in the iCache Geode Mobile Wallet. http://techcrunch.com/2012/08/06/testing-the-icache-geode-mobile-wallet-a-card-that-clones-your-credit-cards/

Google Wallet offers a system to store user identity and credentials, for use with payment information in particular such as VISA, MasterCard, American Express or the like. Google Wallet stores credential information in an application, and backs up that information on secure Google servers http://www.zdnet.com/google-wallet-goes-cloud-based-to-support-all-major-credit-debit-cards-7000001988/

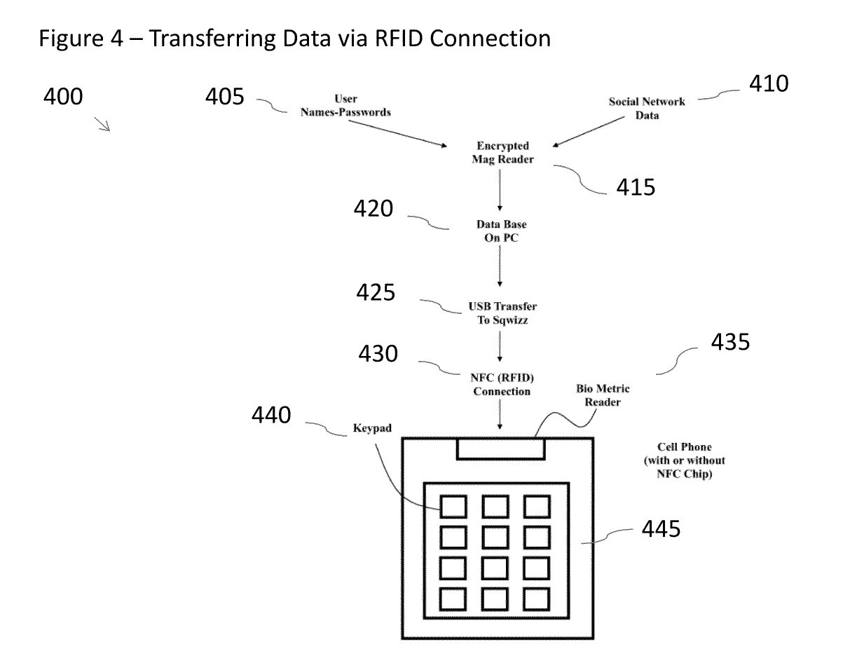

The Poken-like Device has a unique serial encoded IC and can talk to the dial pad on the mobile payment device, for example the iPhone or Smartphone, as a security PIN Pad. An application on the network allows the Poken-like device to pair with the mobile payment device using NFC, Bluetooth or Wifi transmitters. The Poken-like Device uses HSM DUKPT technology for session secure control. It need not be on the Network device to read and store NFC Data. The device uses store and forward to work synchronously or asynchronously. Loading credentials onto the Poken-like device is done either by the bank or the mobile payment device. If the mobile payment device is used, a user's credentials may be read and loaded onto the Poken-like Device by swiping the magstripe of a credit card or other payment card through a device reader connected to the mobile payment device (FIG. 4).

When the Padloc (formerly known as iSquizz) is within defined proximity to the mobile payment device (phone), the application either launches automatically or is user invoked. Once the Padloc is authenticated and communicating with the phone, the user can “pull” one credential from the Padloc to be used on the phone from the TPM of the NFC chip.

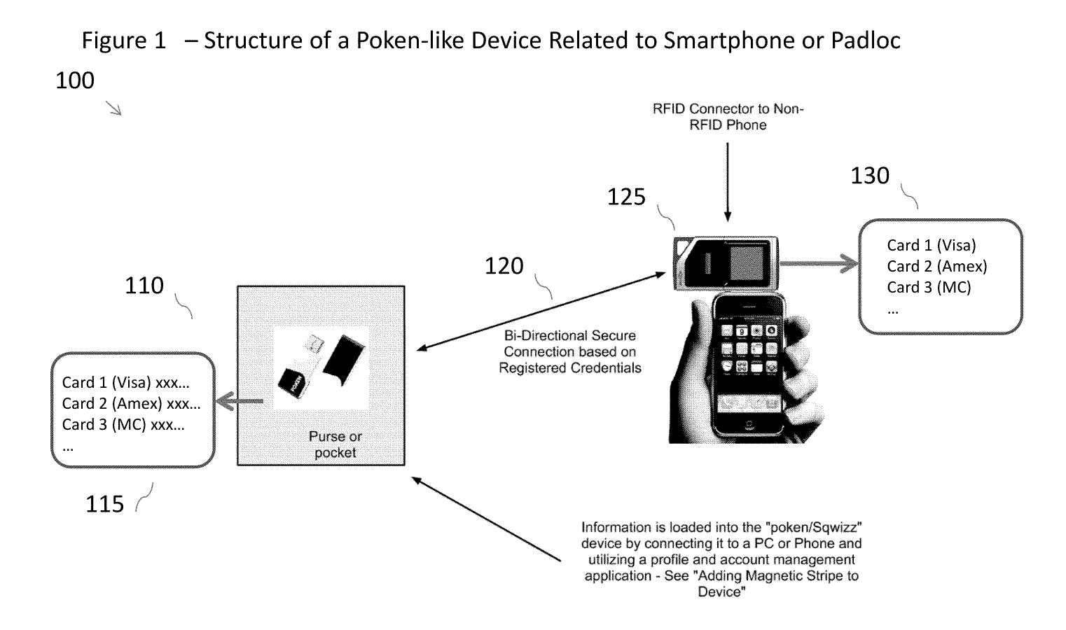

An example is in FIG. 1. The Padloc is connected to the phone. Padloc communicates bi-directionally with the Poken-like device in the user's pocket or purse where the user's credentials are stored. The credentials are not in the Padloc device or in the application on the phone. The Poken-like device communicates via Bluetooth, Wi-Fi, RFID, or other by using a PIN entry device. An important novelty point is that credentials are not in the user's Padloc or mobile payment device (e.g. smartphone or iPhone); they are only on the Poken-like Device.

To make a payment, a user may start a Google Wallet application on a smartphone and enter a PIN. Although this seems like a secure operation, in reality the numbers are only a graphical representation on an application that is processed by the smartphone's operating system which is able to be hacked and read by others. In this invention, the credentials reside in the Poken-like Device and are only “tunneled through” and not decrypted by the smartphone, and sent directly to the payment site requiring the credentials. This way a hacker cannot intercept and decode the credentials while they are in transit to the payment site. Furthermore, if the smartphone, iPhone, or Padloc device is lost or stolen, the user's credentials are not compromised.

Related Patents: U.S. Pat. No. 6,747,547 B2 Jun. 8, 2004 (Benson) Communication Method and Apparatus Improvements

Therefore, there is a need for Storing and Forwarding Credentials Securely from one RFID device to Another that is not being met in the marketplace today.

This and all other referenced patents and applications are incorporated herein by reference in their entirety. Furthermore, where a definition or use of a term in a reference, which is incorporated by reference herein is inconsistent or contrary to the definition of that term provided herein, the definition of that term provided herein applies and the definition of that term in the reference does not apply.

### DRAWINGS

### Summary of the Invention

This invention describes a system and method of securely storing credentials onto a tamperproof module with a Poken-like Device, and using that device in connection with a Padloc, iPhone or Smartphone in a known paired relationship to securely provide user credentials for resources the Padloc, iPhone or Smartphone applications are attempting to access.

### BRIEF DESCRIPTION OF THE DRAWINGS

FIG. 1 is a diagram of a Poken-like Device related to a Smartphone or Padloc device.

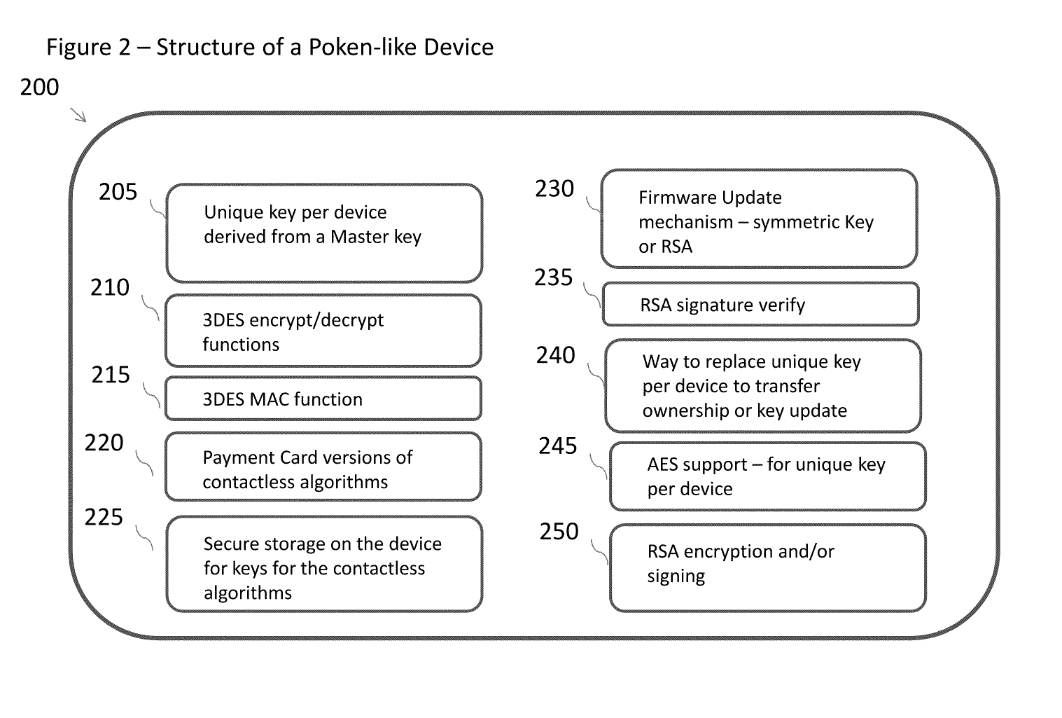

FIG. 2 is a diagram of a Poken-like Device and its internal structure.

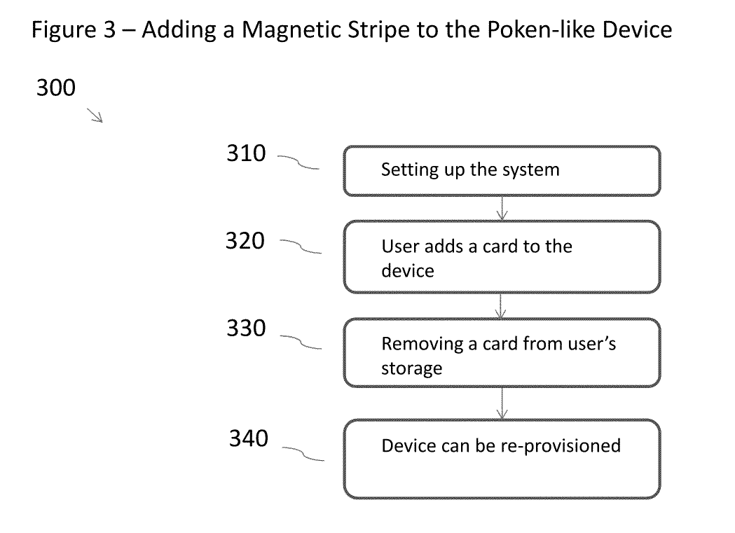

FIG. 3 is a diagram of the steps needed to add a magnetic stripe to the Poken-like device.

FIG. 4 is a diagram of the data flow of transferring data via an RFID Connection.

### DETAILED DESCRIPTION

FIG. 1: Structure of a Poken-like Device Related to Smartphone or Padloc. (100). Secure credentials are encrypted and stored in a small Poken-like Device (110), to keep them out of the phone OS. The coordinates of the database on the Poken-like Device (115) is mirrored in an application on the Padloc device (125) to know which location the credential is stored at (130). The device is cryptographically paired with the credentials of a specific or defined set of phones or computers (120). The Poken-like Device and the phone automatically pair using Bluetooth, Wi-Fi, or the like (120). When the Poken-like Device is within defined proximity to the Padloc or mobile payment device and are authenticated and communicating, the user can “pull” one credential from the Poken-like Device to be used on the phone from the TPM of the NFC chip (120).

FIG. 2: The Structure of a Poken-like Device (200). Minimum-functionality in the Poken-like device should include:

A unique key per device derived from a master key, injected at the factory (205). 3DES encrypt/decrypt functions, CBC (210) and 3DES MAC function (CBC-MAC) (215) are used. The device should include VISA, MasterCard, Discover, and Amex versions of contactless algorithms to identify the card and the number to the device, secure access to phone, and the like (220), and secure storage on the device for a number of keys for the contactless algorithms (225).

Optional but strongly suggested functionality in the Poken-like device should include: A firmware update mechanism which can be done based on symmetric key, but would be much cleaner with RSA or other public key mechanism. (230) Also, an RSA signature verify would be useful for a firmware update (235) and a way to replace the unique key per device to transfer ownership or just update keys in case of master key compromise. (240)

It is also useful in the Poken-like Device to have: AES support for unique key per device (could be AES) to improve security arguments and demonstrate security. (245) RSA encryption and/or signing may also be used to increase the number of supported protocols. (250)

FIG. 3: Adding a Magnetic Stripe to the Poken-like Device (300)

Note that we assume that NFC Data may hold the device keys, or may transfer ownership to a financial institution. Therefore, we refer only to a “host” to represent the owner of the master key.

### Setting up the System: (310)

1. Generate an RSA key pair in the Atalla device at the host. This key will be used for sending track 2 data from the scanning endpoint to the Atalla.
2. Create an applet or other software for the scanning endpoints (ie. PCs) that will take the host's public key and use it to encrypt the user's ID, password, and scanned track 2 data.
3. Note that applet should check the quality of the password at the time it is entered. (Don't allow 1212, etc.). If this is a new account, require that the password be entered twice.
4. Generate a random storage master key that will be used to store individual data. Each user will have a derived unique storage key.
5. Each user will have a storage blob which is encrypted and MACed. This blob is tied to both the user ID and the password. The blob should be able to be easily parsed, probably in a tag length value format: Password tag, password length, password, track 2 tag, track 2 length for card 1, track 2 data for card 1, track 2 tag, track 2 length for card 2, track 2 data for card 2, etc. The blob will be updated whenever a new card is added. The device ID will be needed in the blob if a card deletion does not require an additional password [see Additional Functions below].

When a user adds a card to the device: (320)
1. The user contacts the host web page and downloads the scanning applet (could also be software distributed with device).
2. The user scans the magnetic stripe at a PC.
3. The applet encrypts the user ID, password, track 2 data, device ID and device transaction counter using the host's RSA public key and sends the result over the web. The user ID should be separate from the device ID to simplify user transition between devices.
4. The host's web interface sends the cryptogram from step 3 to the Atalla Network Security Processor (NSP) and any existing stored data for that user ID.
5. NSP processing:
a. Decrypt the data from step 3 using RSA.
b. Derive the storage keys from the user ID and master storage key.
c. If the host sent an existing blob for the current user ID, decrypt and verify the MAC on the blob. If the MAC fails, return an error.
d. Compare the password from the encrypted blob to the password from the RSA decryption. (Stored password may be a hash.) If the two do not match, return an error.
e. Concatenate the new data to the end of the existing clear blob, re-encrypt and MAC using the user's storage key.
f. Derive the device's unique key and derive session keys. Encrypt and MAC the card data for the device using the session keys.
g. Return updated blob for storage and encrypted track data for transmission to device.
h. At the host, CBC encryption and CMAC are probably the best choices for security and comfort level for auditors.

Removing a card from the user's storage: (330) Note: this is an additional function needed.
1. Device can create a message when the card is deleted that is encrypted and MAC'ed with device derived session key.
2. NSP will support a command that takes in encrypted delete message and user blob and removes the data from the blob.

Device can be re-provisioned providing: (340) Note: this is an additional function needed.
1. User authenticates themselves with a service such as Authentify or the like.
2. Proper credential (such as PIN) is provided correctly
3. Device is connected to a network

FIG. 4: Transferring Data via an RFID Connection (400). User names and passwords (405) and social network data (410) may be combined with the function of a magnetic card reader (415) to put credential information into a database on a PC (420). This data may be transferred via USB to the Padloc device (formerly known as Squizz) (425). Padloc will have a connection via RFID (or NFC) to a Cell Phone (with or without an NFC Chip) used as a mobile payment device (445). The cell phone (445) will have a Bio Metric Reader (435), a Keypad (440) or both.

What is claimed:

1. A system that stores and forwards multiple credentials securely in a small device comprising:
a Poken-like Device that implements a secure tamperproof module and is able to electronically pair with other payment devices;
a means for acquiring payment credentials to be added to said Poken-like Device;
a means for encrypting said credentials to create an encrypted credential;
a means for transferring said encrypted credential to said Poken-like Device;
a means for cryptographically pairing said Poken-like Device with a payment device;
a means for selecting a specific encrypted credential to be retrieved by said payment device from said Poken-like Device;
a means for retrieving said specific encrypted credential onto said payment device.

2. A system as in claim 1 further comprising:
the means for securely paring said Poken-like Device with a payment device includes entering a correct PIN, a biometric read, or both.

3. A method for storing and forwarding multiple credentials securely with a Poken-like Device that implements a secure tamperproof module and is able to electronically pair with other payment devices comprising the steps of:
acquiring payment credentials to be added to said Poken-like Device;
encrypting said credentials to create an encrypted credential;
transferring said encrypted credential to said Poken-like Device;
pairing cryptographically said Poken-like Device with a payment device;
selecting a specific encrypted credential from the Poken-like Device by said payment device;
retrieving said encrypted credential from the Poken-like Device to said payment device.

4. A method as in claim 3 further comprising the steps of:
pairing cryptographically said Poken-like Device with a payment device using the entering of a correct PIN, a biometric read, or both.
